(19) United States
(12) Patent Application Publication
(10) Pub. No.: US 2022/0219447 A1
(43) Pub. Date: Jul. 14, 2022

(54) SYSTEM AND METHOD FOR REPLACING AND CLEANING A STENCIL IN A STENCIL PRINTER

(71) Applicant: Illinois Tool Works Inc., Glenview, IL (US)

(72) Inventors: Matthew F. Schumacher, Edina, MN (US); Weidong Wang, Eden Prairie, MN (US); Bruce C. Seaton, Essex (GB); James Lynch, Uxbridge, MA (US)

(21) Appl. No.: 17/568,081

(22) Filed: Jan. 4, 2022

Related U.S. Application Data
(60) Provisional application No. 63/136,403, filed on Jan. 12, 2021.

(51) Int. Cl. B41F 35/00; B41F 15/12

(52) U.S. Cl. CPC B41F 35/003; B41P 2235/21; B41P 2227/60; B41F 15/12

(57) ABSTRACT

Systems and methods of removing and cleaning a stencil in a stencil printer include removing a used stencil from a stencil printer with the assistance of a movable cart, transporting the used stencil by the movable cart to a cleaning station, removing the used stencil from the movable cart, delivering the used stencil to the cleaning station, cleaning the stencil, removing a cleaned stencil from the cleaning station, and delivering the cleaned stencil to the movable cart for future use.

### CROSS-REFERENCE TO RELATED APPLICATION

This application claims the benefit under 35 U.S.C. § 119(e) of co-pending U.S. Provisional Patent Application No. 63/136,403 titled SYSTEM AND METHOD FOR REPLACING AND CLEANING A STENCIL IN A STENCIL PRINTER filed on Jan. 12, 2021, which is incorporated herein by reference in its entirety for all purposes.

### BACKGROUND OF THE DISCLOSURE

### 1. Field of Invention

This application relates generally to stencil printers and related methods to print viscous materials, e.g., solder paste, on an electronic substrate, e.g., a printed circuit board (PCB), and more particularly to systems and methods for replacing and cleaning a stencil in a stencil printer.

### 2. Discussion of Related Art

In manufacturing a surface-mount printed circuit board, a stencil printer can be used to print solder paste onto the circuit board. Typically, a circuit board having a pattern of pads or some other conductive surface onto which solder paste will be deposited is automatically fed into the stencil printer; and one or more small holes or marks (known as “fiducials”) on the circuit board are used to properly align the circuit board with the stencil or screen of the stencil printer prior to printing solder paste onto the circuit board. In some systems, an optical alignment system embodying a vision system is used to align the circuit board with the stencil.

Once the circuit board has been properly aligned with the stencil in the printer, the circuit board is raised to the stencil, solder paste is dispensed onto the stencil, and a wiper blade (or squeegee) traverses the stencil to force the solder paste through apertures in the stencil and onto the circuit board. As the squeegee is moved across the stencil, the solder paste tends to roll in front of the blade, which desirably causes mixing and shearing of the solder paste so as to attain a desired viscosity to facilitate filling of the apertures in the screen or stencil. The solder paste typically is dispensed onto the stencil from a standard cartridge. The stencil is then separated from the circuit board and the adhesion between the circuit board and the solder paste causes most of the material to stay on the circuit board. Material left on the surface of the stencil is removed in a cleaning process before additional circuit boards are printed.

Another process in the printing of circuit boards involves inspection of the circuit boards after solder paste has been deposited on the surface of the circuit boards. Inspecting the circuit boards is important for determining that clean electrical connections can be made. An excess of solder paste can lead to shorts, while too little solder paste in appropriate positions can prevent electrical contact. Generally, the vision inspection system is further employed to provide a two-dimensional or a three-dimensional inspection of the solder paste on the circuit board.

Present day stencil printers require manual intervention to perform routine operations. For example, during a changeover, an operator must perform many manual tasks, such as changing a stencil, replacing a solder paste cartridge, replacing squeegee blades, and replacing support tooling. Each of these tasks require the operator to manually perform the task. For example, with most stencil printers, the operator must unlock the stencil, remove the stencil, properly insert a replacement stencil, and lock the replacement stencil in place. A changeover operation can take as long as 30 minutes, during which the stencil printer is not operating, which may result in the PCB fabrication line not operating.

### SUMMARY OF THE DISCLOSURE

One aspect of the present disclosure is directed to a method of removing and cleaning a stencil in a stencil printer. In one embodiment, the method comprises: removing a used stencil from a stencil printer with the assistance of a movable cart; transporting the used stencil by the movable cart to a cleaning station; removing the used stencil from the movable cart; delivering the used stencil to the cleaning station; cleaning the stencil; removing a cleaned stencil from the cleaning station; and delivering the cleaned stencil to the movable cart for future use.

Embodiments of the method further may include performing the method without the need of human intervention. The method may be performed on at least two stencil printers. The movable cart may be configured to transport other items, including trays configured to support squeegee blades and tooling. The movable cart may include an interface configured interact with a docking station associated with the stencil printer and the cleaning station. The movable cart may include at least one pin that is received within at least one guide associated with the stencil printer and the cleaning station to register the movable cart with the stencil printer prior and the cleaning station, respectively, to fully dock the at least one delivery device. The method further may include identifying an item by obtaining an image of the item and verifying whether the item is the correct item based on a predetermined identification mark.

Another aspect of the present disclosure is directed to a system of removing and cleaning a stencil in a stencil printer. In one embodiment, the system comprises a stencil printer having a removable stencil, a cleaning station, and a movable cart configured to remove a used stencil from a stencil printer, transport the used stencil cart to the cleaning station, remove the used stencil from the movable cart, deliver the used stencil to the cleaning station, remove a cleaned stencil from the cleaning station, and deliver the cleaned stencil to the movable cart for future use.

Embodiments of the system further may include a paste pan configured to support excess solder paste. The system further may include at least one additional stencil printer. The movable cart may be configured to transport other items, including trays configured to support squeegee blades and tooling. The movable cart may include an interface configured to interact with a docking station associated with the stencil printer and a docking station associated with the cleaning station. The movable cart may include at least one pin that is received within at least one guide associated with the stencil printer and at least one guide associated with the cleaning station to register the movable cart with the stencil printer and the cleaning station, respectively, prior to fully docking the movable cart. The movable cart may include an imager to identify an item by obtaining an image of the item and verifying whether the item is the correct item based on a predetermined identification mark.

Yet another aspect of the present disclosure is directed to a method of reclaiming solder paste from a stencil printer. In one embodiment, the method comprises: removing excess solder paste from a stencil printer with the assistance of a movable cart; transporting the excess solder paste by the movable cart to a solder paste reclamation station; removing the excess solder paste from the movable cart; delivering the excess solder paste to the solder paste reclamation station; storing the excess solder paste for future use.

Embodiments of the method further may include containing the excess solder paste within a paste pan. The movable cart may include an interface configured interact with a docking station associated with the stencil printer and the solder paste reclamation station. The movable cart may include at least one pin that is received within at least one guide associated with the stencil printer and the solder paste reclamation station to register the movable cart with the stencil printer prior and the solder paste reclamation station, respectively, to fully dock the at least one delivery device. The method further may include identifying an item by obtaining an image of the item and verifying whether the item is the correct item based on a predetermined identification mark.

Another aspect of the present disclosure is directed to a system of reclaiming solder paste from a stencil printer. In one embodiment, the system comprises a stencil printer, a solder paste reclamation station, and a movable cart configured to remove excess solder paste from the stencil printer, transport the excess solder paste to the solder paste reclamation station, remove the excess solder paste from the movable cart; and deliver the excess solder paste to the solder paste reclamation station.

Embodiments of the system further may include containing the excess solder paste is contained within a paste pan. The system further may include at least one additional stencil printer. The movable cart may be configured to transport other items, including stencils and trays configured to support squeegee blades and tooling. The movable cart may include an interface configured to interact with a docking station associated with the stencil printer and a docking station associated with the solder paste reclamation station. The movable cart may include at least one pin that is received within at least one guide associated with the stencil printer and at least one guide associated with the solder paste reclamation station to register the movable cart with the stencil printer and the solder paste reclamation station, respectively, prior to fully docking the movable cart. The movable cart may include an imager to identify an item by obtaining an image of the item and verifying whether the item is the correct item based on a predetermined identification mark.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a front view of a stencil printer;

FIG. 2 is a front perspective view of a stencil printer;

FIG. 3 is a top plan view of the stencil printer illustrated in FIG. 2 with portions removed;

FIG. 4 is a diagram showing a method of replacing a stencil within a stencil printer;

FIG. 5 is a schematic view of a movable cart of an embodiment of the present disclosure, the movable cart being proximate to a stencil printer;

FIG. 6 is a schematic view of the movable cart being configured to deliver and receive stencils to and from the stencil printer;

FIG. 7 is a schematic view of the movable cart being configured to deliver and receive items to and from the stencil printer;

FIG. 8 is a perspective view of a movable cart of an embodiment of the present disclosure positioned adjacent a stencil printer;

FIG. 9 is a perspective view of the movable cart positioned adjacent a stencil cleaner;

FIG. 10 is a perspective view of the movable cart and the stencil cleaner, with a stencil flipper shown to be schematically integrated in the stencil cleaner;

FIG. 11 is a perspective view of the movable cart and the stencil cleaner, with a stencil flipper shown to be disposed in front of the stencil cleaner;

FIG. 12 is a perspective view of the movable cart and the stencil cleaner, with a robotic arm shown to be disposed adjacent the stencil cleaner;

FIG. 13 is a perspective view of stencils stacked upon one another;

FIG. 14 is a perspective view of squeegee blades;

FIG. 15 is a perspective view of tooling;

FIG. 16 is a diagram showing a method of reclaiming solder paste from a stencil printer;

FIG. 17 is a perspective view of a solder paste reclamation system including a paste pan.

### DETAILED DESCRIPTION OF THE DISCLOSURE

The present disclosure relates generally to material application machines (referred to herein as “stencil printers,” “screen printers,” “printing machines,” or “printers”) and other equipment utilized in a surface mount technology (SMT) process lines and configured to apply an assembly material (e.g., solder paste, conductive ink, or encapsulation material) onto a substrate (e.g., a printed circuit board, referred to herein as an “electronic substrate,” a “circuit board,” a “board,” a “PCB,” a “PCB substrate,” a “substrate,” or a “PCB board”) or to perform other operations, such as inspection, rework, or placement of electronic components onto a substrate. Specifically, embodiments of the present disclosure are described below with reference to stencil printers used to produce printed circuit boards.

For the purposes of illustration only, and not to limit the generality, the present disclosure will now be described in detail with reference to the accompanying figures. This disclosure is not limited in its application to the details of construction and the arrangement of components set forth in the following description or illustrated in the drawings. The principles set forth in this disclosure are capable of other embodiments and of being practiced or carried out in various ways. Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated reference is supplementary to that of this document; for irreconcilable inconsistencies, the term usage in this document controls.

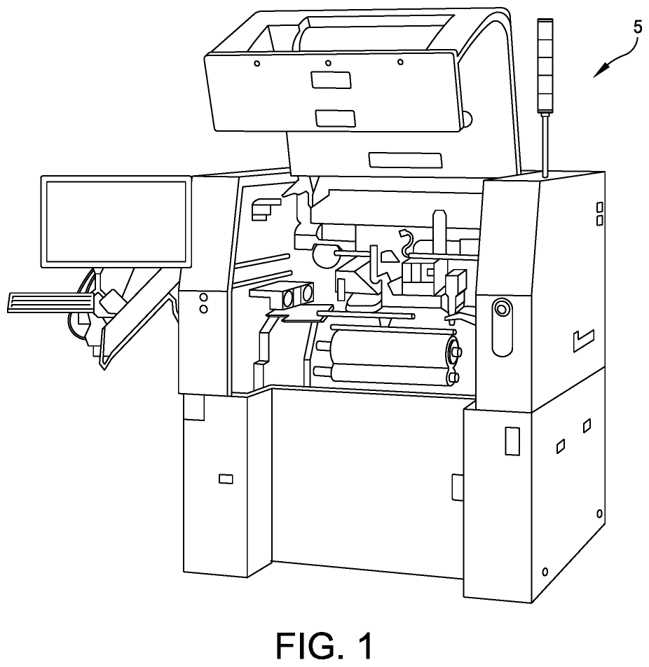

For purposes of illustration, embodiments of the present disclosure will now be described with reference to a stencil printer used to print an assembly material, such as solder paste, onto a circuit board. One skilled in the art will appreciate, however, that embodiments of the present disclosure are not limited to stencil printers that print solder paste onto circuit boards, but rather, may be used in other applications requiring dispensing of other viscous assembly materials, such as glues and encapsulents. For example, the apparatus may be used to print epoxy for use as underfill for chip-scale packages. Further, stencil printers in accordance with embodiments of the present disclosure are not limited to those that print assembly materials on circuit boards, but rather, include those used for printing other materials on a variety of substrates, such as semiconductor wafers. Also, the terms screen and stencil may be used interchangeably herein to describe a device in a printer that defines a pattern to be printed onto a substrate. In certain embodiments, the stencil printer may include a Momentum® or an Edison™ series stencil printer platform offered by ITW Electronic Assembly Equipment of Hopkinton, Mass. An exemplary stencil printer is generally designated at 5 in FIG. 1. In this embodiment, the stencil printer 5 is a Momentum® series stencil printer platform offered by ITW Electronic Assembly Equipment of Hopkinton, Mass.

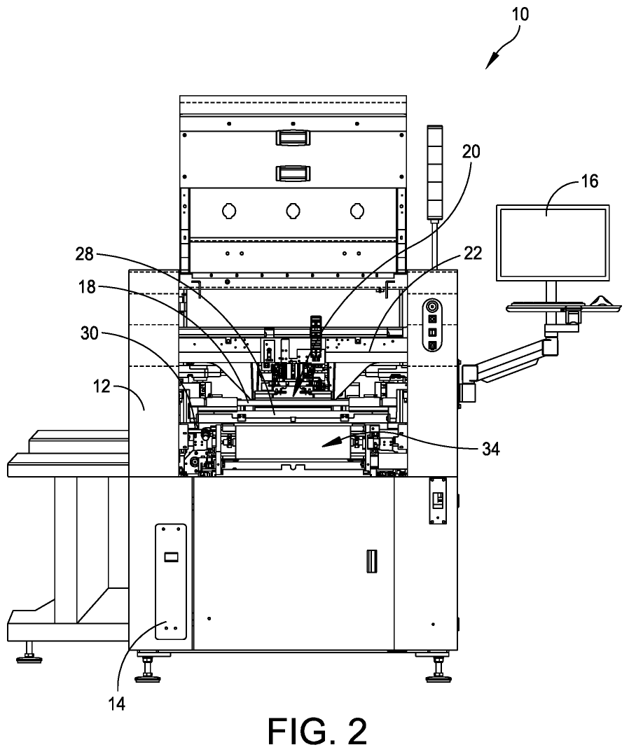

Referring to FIG. 2, there is generally indicated at 10 a stencil printer of an embodiment of the disclosure. As shown, the stencil printer 10 includes a frame 12 that supports components of the stencil printer. The components of the stencil printer may include, in part, a controller 14, a display 16, a stencil 18, and a print head or print head assembly, generally indicated at 20, which is configured to apply the solder paste in a manner described in greater detail below.

As shown in FIG. 2 and described below, the stencil and the print head assembly may be suitably coupled or otherwise connected to the frame 12. In one embodiment, the print head assembly 20 may be mounted on a print head assembly gantry 22, which may be mounted on the frame 12. The print head assembly gantry 22 enables the print head assembly 20 to be moved in the y-axis direction under the control of the controller 14 and to apply pressure on the print head assembly as it engages the stencil 18. In a certain embodiment, the print head assembly 20 may be placed over the stencil 18 and may be lowered in the z-axis direction into contact and sealingly engage the stencil.

The stencil printer 10 may also include a conveyor system having rails (not shown) for transporting a printed circuit board (sometimes referred to as a “printed wiring board,” “substrate,” or “electronic substrate” herein) to a print position in the stencil printer. The rails sometimes may be referred to herein as a “tractor feed mechanism,” which is configured to feed, load or otherwise deliver circuit boards to the working area of the stencil printer, which may be referred to herein as a “print nest,” and to unload circuit boards from the print nest.

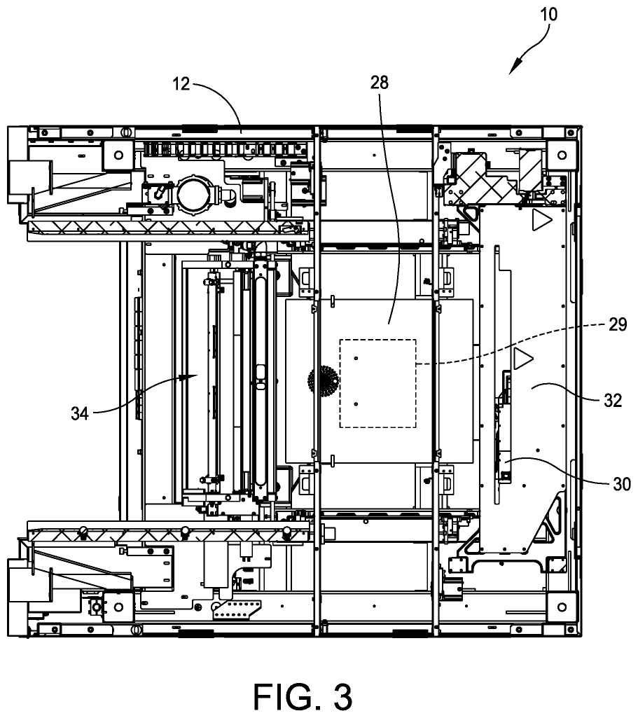

Referring additionally to FIG. 3, the stencil printer 10 has a support assembly 28 to support the circuit board 29 (shown in dashed lines), which raises and secures the circuit board so that it is stable during a print operation. In certain embodiments, the substrate support assembly 28 further may include a particular substrate support system, e.g., a solid support, a plurality of pins or flexible tooling, which is positioned beneath the circuit board when the circuit board is in the print position. The substrate support system may be used, in part, to support the interior regions of the circuit board to prevent flexing or warping of the circuit board during the print operation.

In one embodiment, the print head assembly 20 may be configured to receive solder paste from a source, such as a dispenser, e.g., a solder paste cartridge, that provides solder paste to the print head assembly during the print operation. Other methods of supplying solder paste may be employed in place of the cartridge. For example, solder paste may be manually deposited between the blades or from an external source. Additionally, in a certain embodiment, the controller 14 may be configured to use a personal computer having a suitable operating system, such as a Microsoft Windows® operating system provided by Microsoft Corporation, with application specific software to control the operation of the stencil printer 10. The controller 14 may be networked with a master controller that is used to control a production line for fabricating circuit boards.

In one configuration, the stencil printer 10 operates as follows. A circuit board 29 is loaded into the stencil printer 10 using the conveyor rails. The support assembly 28 raises and secures the circuit board 29 to a print position. The print head assembly 20 is then lowered in the z-axis direction until blades of the print head assembly contact the stencil 18 at a desired pressure. The print head assembly 20 is then moved in the y-axis direction across the stencil 18 by the print head assembly gantry 22. The print head assembly 20 deposits solder paste through apertures in the stencil 18 and onto the circuit board 29. Once the print head assembly has fully traversed the stencil 18 across the apertures, the print head assembly is lifted off the stencil and the circuit board 29 is lowered back onto the conveyor rails. The circuit board 29 is released and transported from the stencil printer 10 so that a second circuit board may be loaded into the stencil printer. To print on the second circuit board 29, the print head assembly is lowered in the z-axis direction into contact with the stencil and moved across the stencil 18 in the direction opposite to that used for the first circuit board.

An imaging system 30 may be provided for the purposes of aligning the stencil 18 with the circuit board 29 prior to printing and to inspect the circuit board after printing. In one embodiment, the imaging system 30 may be disposed between the stencil 18 and the support assembly 28 upon which a circuit board is supported. The imaging system 30 is coupled to an imaging gantry 32 to move the imaging system. In one embodiment, the imaging gantry 32 may be coupled to the frame 12, and includes a beam that extends between side rails of the frame 12 to provide back and forth movement of the imaging system 30 over the circuit board 29 in a y-axis direction. The imaging gantry 32 further may include a carriage device, which houses the imaging system 30, and is configured to move along the length of the beam in an x-axis direction. The construction of the imaging gantry 32 used to move the imaging system 30 is well known in the art of solder paste printing. The arrangement is such that the imaging system 30 may be located at any position below the stencil 18 and above the circuit board 29 to capture an image of predefined areas of the circuit board or the stencil, respectively.

After one or more applications of the solder paste to circuit boards, excess solder paste may accumulate at the bottom of the stencil 18 and a stencil wiper assembly, generally indicated at 34, and may move beneath the stencil to remove the excess solder paste. In other embodiments, the stencil 18 may be moved over the stencil wiper assembly.

As mentioned above, stencil printers require manual intervention to perform replacement of certain parts and/or replenishment operations. For example, a typical stencil requires replacement after a certain period of time, e.g., four hours. Also, stencils need replacement for separate production runs. In addition, solder paste cartridges, which supply temperature-controlled solder paste to the stencil printer, require replacement over time, e.g., within four hours or less. A separate production run may require a different solder paste material. Another item requiring periodic replacement is squeegee blades, which are subject to wearing during use. And finally, tooling used to support a substrate in a print position is subject to replacement when changing from one production product to another.

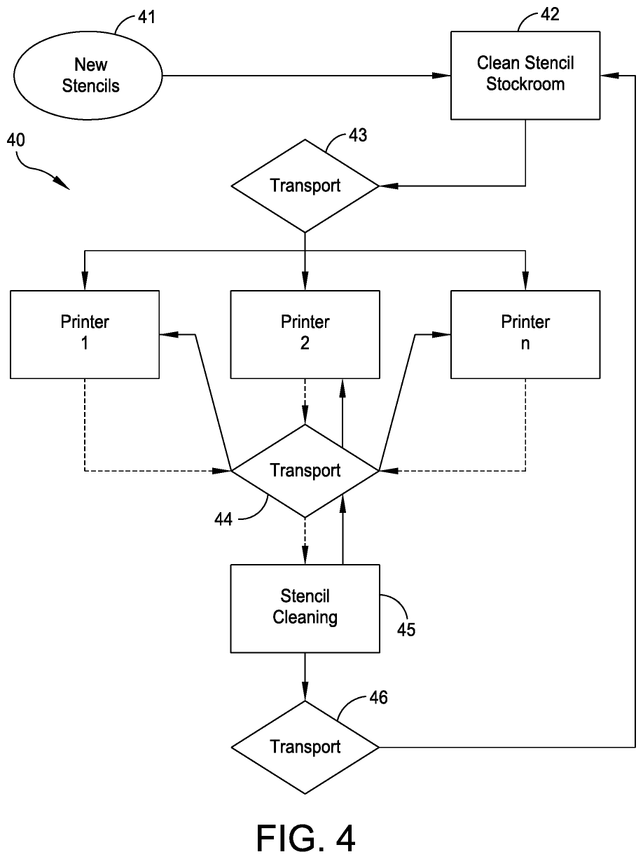

Referring to FIG. 4, a method of replacing a stencil is generally designated at 40. Stencils are used to print solder paste onto a printed circuit board. Stencils are often fabricated from stainless steel or nickel. As shown, when a request for a new stencil is made at 41, either for a new production run or because of wear on an existing stencil, a clean stencil is retrieved from a stencil stockroom at 42 and transported at 43 to one of several stencil printers identified by “Printer 1,” “Printer 2” and “Printer 3.” The stencil printers can be part of a single production line used to fabricate printed circuit boards or part of several production lines. The number of stencil printers can vary. At the production line, the “dirty” or used stencil is removed from the stencil printer and the “clean” or new stencil is inserted into the stencil printer and secured for use. The dirty stencil is transported at 44 to a stencil cleaning station 45 where the stencil is cleaned and ready for reuse. Once cleaned, the stencil is transported back at 46 to the clean stencil stockroom 42, where the stencil is ready to be reused during the same or different production run.

In one embodiment, a method of replacing a stencil and/or items placed on trays may include, when a request for a new stencil and/or item on a tray is made, either for a new production run or because of wear on an existing stencil, a clean stencil and/or item is provided on a movable cart. At the production line, the “dirty” or used stencil and/or item is removed from the stencil printer and the “clean” or new stencil and/or item is inserted into the stencil printer from the movable cart and secured for use. The dirty stencil and/or item is transported to a cleaning station where the stencil and/or item is cleaned and ready for reuse. Once cleaned, the stencil and/or item may be transported back to the stencil printer or a stockroom, where the stencil and/or is can be reused during the same or different production run.

Embodiments of the present disclosure are directed to a delivery system that is configured to automate a changeover process for a stencil printer and to implement one or more of the methods described with reference to FIG. 4. In one embodiment, the delivery system includes a movable cart that is configured to engage a stencil printer to supply and receive replacement and replenishment parts and materials to the stencil printer. For example, the stencil printer may include a docking station that is configured to receive the movable cart. The docking station may include an interface that enables the movable cart to communicate with the stencil printer. A single movable cart may be configured to include changeover stencils and/or replacement stencils. During a changeover, for example, the stencil printer must be reconfigured to produce different items. Thus, a new stencil may be employed within the stencil printer to produce a different product.

The changeover process described herein can be achieved by a single movable cart that is configured to replace and/or replenish each item. In other embodiments, more than one movable cart can be provided. For example, for stencil changeover, the movable cart is configured to support a predetermined number of stencils. The movable cart and/or the stencil printer can be configured to identify the stencils, store the stencils, transport the stencils to and from the stencil printer, inspect the stencils, and interface with the stencil printer. The movable cart also may be configured to remove used parts, such as stencils, from the stencil printer.

Embodiments of the present disclosure are further directed to a delivery system that is configured to automate a replenishment process for a stencil printer. In one embodiment, the delivery system includes a movable cart that is configured to engage a stencil printer to supply and receive replacement and replenishment parts and materials to the stencil printer. For example, the stencil printer may include a docking station that is configured to receive the movable cart. The docking station may include an interface that enables the movable cart to communicate with the stencil printer. A single movable cart may be configured to include changeover stencils and replacement stencils.

The replenishment process described herein can be achieved by a single movable cart that is configured to replenish replenishable items. In other embodiments, more than one movable cart can be provided. For example, for stencil replenishment, the movable cart is configured to support several replacement solder paste cartridges. The movable cart and/or the stencil printer can be configured to identify the replacement solder paste cartridge, store the cartridges, transport the cartridges to and from the stencil printer, inspect the cartridges, and interface with the stencil printer.

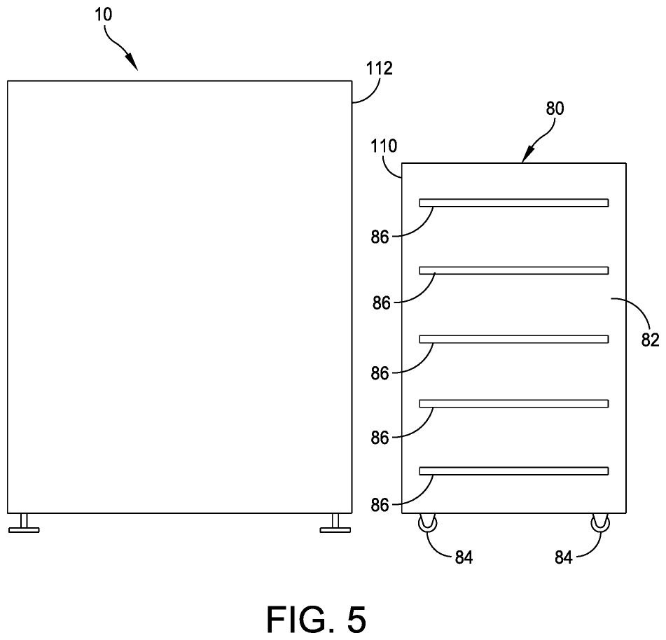

Referring to FIG. 5, in one embodiment, a movable cart, generally indicated at 80, includes a frame or housing 82 configured to support replacement and/or replenishment items. As shown, the frame 82 is generally rectangular and is supported on wheels or casters, each indicated at 84. In one embodiment, the movable cart 80 is configured to be manually moved by an operator by pushing the housing 82 of the movable cart. In this embodiment, the movable cart 80 can be configured with a push bar or a handle. In another embodiment, the movable cart 80 is configured to be automatically moved, either by remote control or by an automated control associated with the movable cart, the stencil printer 10, the production line, and/or some other dedicated control. In this embodiment, the movable cart 80 can include wheels that are driven by a suitable motor and drive train, and a control associated with the movable cart, the stencil printer 10, the production line, and/or some other dedicated control is configured to control the movable cart. The movable cart 80 further can include one or more sensors and/or a vision system, e.g., cameras, to guide the movable cart from a stockroom, for example, to the stencil printer.

The movable cart 80 includes one or more shelves, each indicated at 86, which are configured to store items for the stencil printer 10. For example, the shelves 86 can be specifically designed to support new and used stencils, and/or other items, such as new and spent/used paste cartridges, new and used squeegee blades, and new and used tooling. One or more shelves 86 can be configured to move vertically within the housing 82 to achieve a height suitable to operate with the stencil printer 10. Some shelves 86 may be designated as “clean shelves” to support clean or new items ready to be used within the stencil printer 10. Some shelves 86 may be designated as “dirty shelves” to support used items to be taken away from the stencil printer 10. The shelves 86 can be spaced apart from one another specific distances to receive various items. For example, the shelves 86 can be spaced apart ⅜-inch to 1½-inch from one another to accommodate stencil frame thicknesses.

It should be understood that although the shelves are illustrated to be horizontally oriented, the shelves can be disposed in a vertical orientation in which stencils are inserted into and removed from the shelve slots in a vertical plane.

The movable cart 80 can be configured with one or more devices used to transport items from the movable cart to the stencil printer 10 and from the stencil printer to the movable cart. For example, the device can include grippers or transport arms to assist in removing and inserting items from the movable cart, such as stencils.

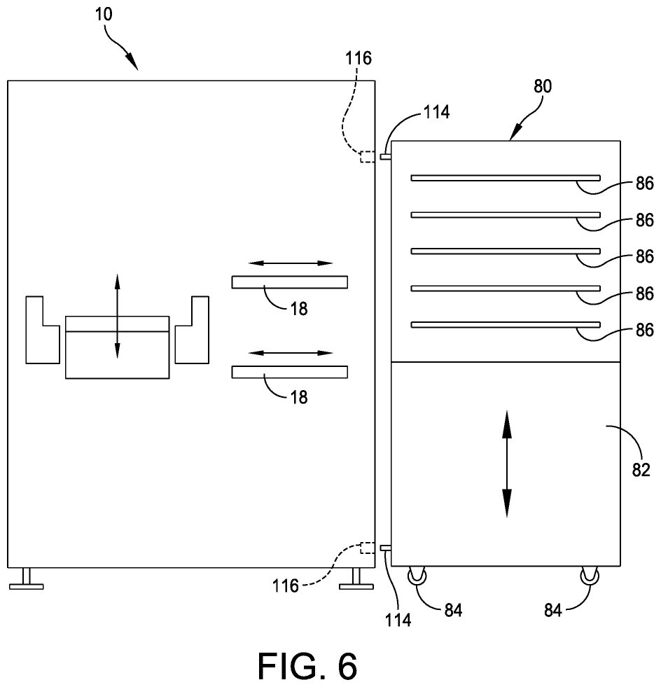

The movable cart 80 can be configured with an interface, which is designed to dock within a docking station provided on the stencil printer 10. In one embodiment, illustrated in FIG. 5, the movable cart 80 includes an interface 110, which is configured to dock within a docking station 112 of the stencil printer 10, both from a mechanic interface and an electronics communication interface. In a particular embodiment, the movable cart 80 can be configured with a unique mechanical interface that mates with a unique mechanical interface of the stencil printer 10. The unique mechanical interfaces can include geometric features. In another embodiment, illustrated in FIG. 6, the movable cart 80 can be configured with pins, each indicated at 114, that are received within guides, each indicated at 116, associated with the stencil printer 10 to register the movable cart with the stencil printer prior to fully docking the movable cart. Other types of guides can be used, such as electrical/magnetic guides, vision guides, sensors, latches, etc. The movable cart 80, when docked within the docking station of the stencil printer 10, can physically engage the stencil printer or be spaced from the stencil printer.

Referring to FIG. 6, the movable cart 80 can be particularly suited to replace stencils, each indicated at 18, within the stencil printer 10. The shelves 86 are configured to support the stencils 18, which are shuttled into and out of the stencil printer 10. The shelves 86 can be configured to move in a vertical direction to achieve a desired elevation. The device associated with the movable cart 80 can be configured to move stencils 18 into and out of the stencil printer 10 from the movable cart once the stencil is at a desired elevation. The movement of the stencils 18 can be achieved automatically under the control of a controller associated with the movable cart 80, the stencil printer 10, and/or the production line.

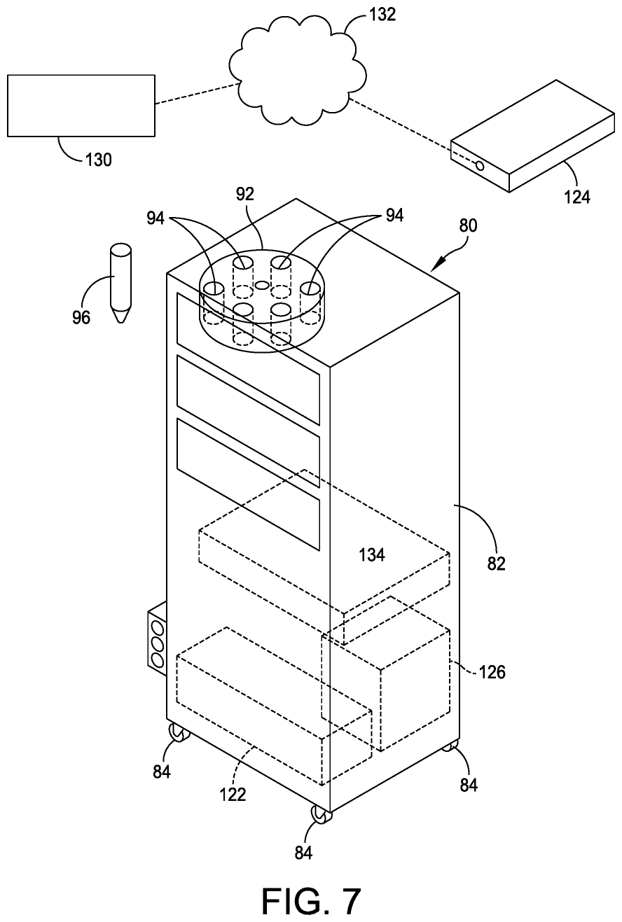

Referring to FIG. 7, in one embodiment, the movable cart 80 includes wheels 84 that are driven by a suitable motor and drive train indicated at 122, and a control, such as a remote control 124 configured to control the movement of the movable cart. The movable cart 80 further includes a power source 126, for example a battery, to power the movement of the movable cart via the motor and drive train 122.

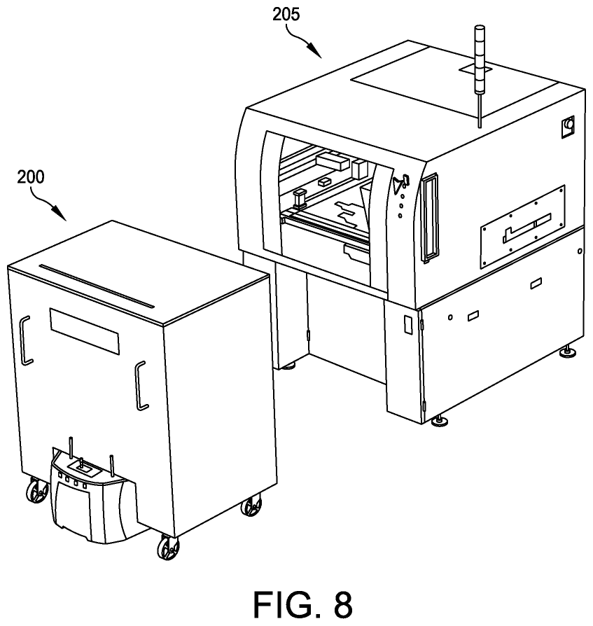

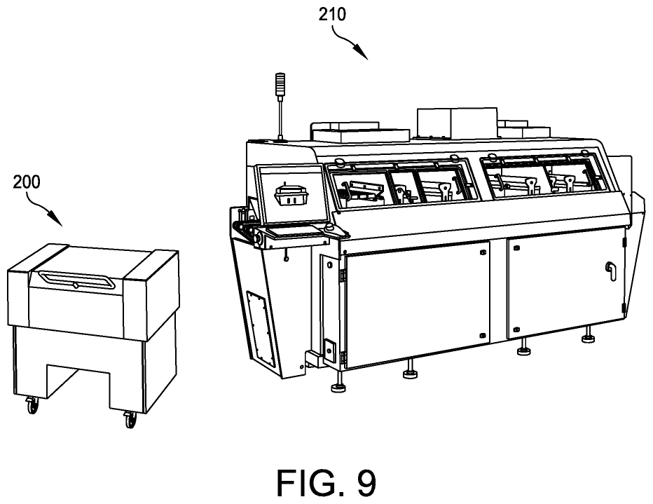

Referring to FIGS. 8 and 9, a movable cart, generally indicated at 200, of an embodiment of the present disclosure is configured to remove and replace stencils from a stencil printer (FIG. 8), generally indicated at 205, and deliver the stencils to a cleaning station (FIG. 9), generally indicated at 210. In one embodiment, the cleaning station 210 is a stencil cleaning station; however, the cleaning station can be configured to clean any number of items, such as squeegee blades and tooling supported in trays. As mentioned above, stencils are used to print solder paste onto a printed circuit board. Stencils are often fabricated from stainless steel or nickel. When a request for a new stencil is required, either for a new production run or because of wear on an existing stencil, a clean stencil is transported by the movable cart 200 to the stencil printer 205. The “dirty” or used stencil is removed from the stencil printer 205 and the “clean” or new stencil is inserted into the stencil printer and secured for use. The dirty stencil is removed from the stencil printer 205 and a new stencil is replaced within the stencil printer. These functions can be performed by the movable cart 200. As shown in FIG. 9, the dirty stencil is transported to the cleaning station 210 where the stencil is cleaned and ready for reuse. The movable cart 200 can perform this function as well. Once cleaned, the stencil can be transported by the movable cart 200 back to the stencil printer 205 or back to a stencil stockroom, where the stencil is ready to be reused during the same or different production run.

As with stencil printer 10, the stencil printer 205 and the cleaning station 210 each can be configured to include a docking station that is configured to receive the movable cart 200. The docking station may include an interface that enables the movable cart 200 to communicate with the stencil printer 205 and the cleaning station 210. As mentioned above with reference to movable cart 80, the movable cart 205 can be configured with a mating interface, which is designed to dock within a docking station provided on the stencil printer 205 and the cleaning station 210. The arrangement is such that the movable cart 200 is configured to dock within a docking station of the stencil printer 205 and the cleaning station 210, both from a mechanic interface and an electronics communication interface. The movable cart 200 can be configured with a unique mechanical interface that mates with unique mechanical interfaces of the stencil printer 205 and the cleaning station 210. The unique mechanical interfaces can include geometric features. As with movable cart 80, the movable cart 200 can be configured with pins that are capable of being received within guides associated with the stencil printer 205 and the cleaning station 210 to register the movable cart with the stencil printer and the cleaning station to fully docking the movable cart. Other types of guides can be used, such as electrical/magnetic guides, vision guides, sensors, latches, etc. The movable cart 200, when docked within the docking station of the stencil printer 205 and/or the docking station of the cleaning station 210, can physically engage the stencil printer and/or the cleaning station or be spaced from the stencil printer and/or the cleaning station 210.

Once docked within the cleaning station 210, the movable cart 200 is configured to deliver the used stencil or stencils to the cleaning station for cleaning. Once cleaned, the movable cart 200 receives the cleaned stencil or stencils for future use.

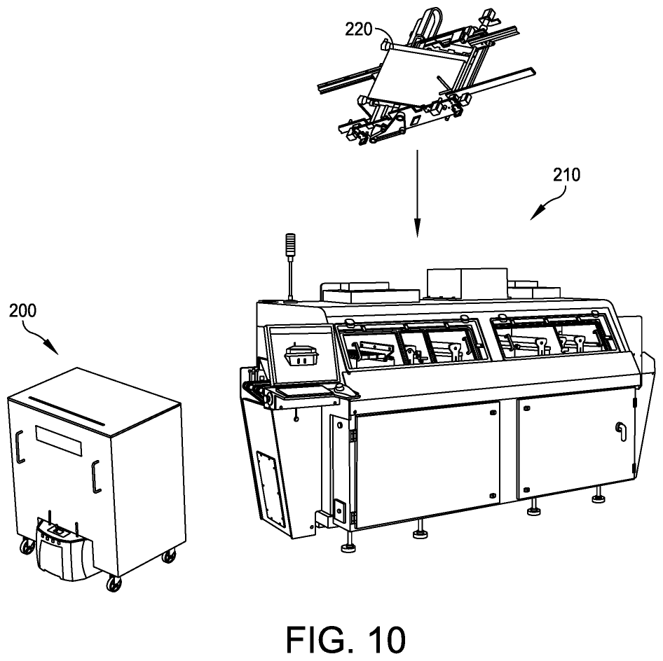

Referring to FIG. 10, the cleaning station 210 can be configured to include a stencil flipper 220, which is integrated within the cleaning station. In one embodiment, the movable cart 200 is configured to receive, store and transport stencils in a horizontal configuration or in a vertical configuration. The stencil flipper 220 is configured to orient the stencils within the cleaning station 210 in a desired orientation.

In some embodiments, the movable cart 200 is configured to receive a tray that is configured to store other items, such as squeegees, tooling, paste pan into cleaner in a desired position, such as a horizontal position.

In some embodiments, the integrated stencil flipper 220 is provided to clean both sides of stencil.

In some embodiments, the cleaning station 210 can be configured with special end effectors to manipulate trays supporting squeegee blades and tooling and paste pans to ensure thorough cleaning.

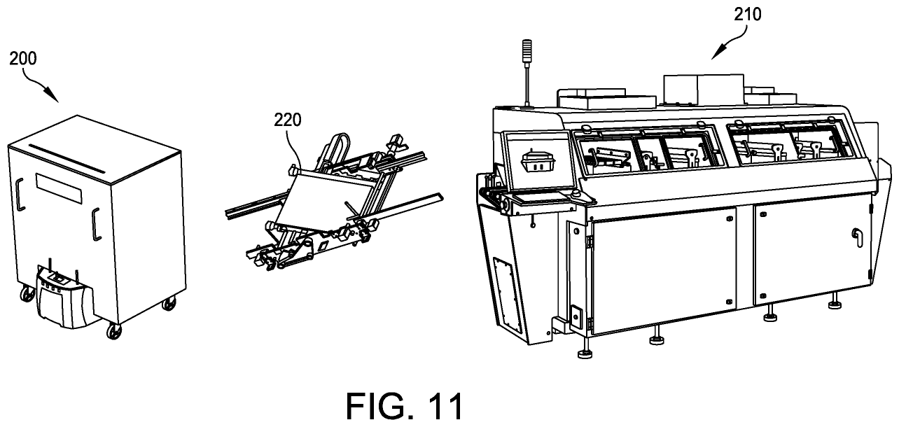

Referring to FIG. 11, the cleaning station 210 can be configured to include the stencil flipper 210, which is provided in front of the cleaning station. In one embodiment, the movable cart 200 is configured to receive, store and transport stencils in a horizontal configuration. The stencil flipper 220 is configured to orient the stencils within the cleaning station 210 in a desired orientation, such as a vertical orientation.

In some embodiments, as the movable cart 200 approaches the cleaning station 210, the stencil flipper 220 rotates the stencil from a horizontal position to a vertical. Cleaning is done within the cleaning station 210 in the vertical position.

In some embodiments, the cleaning station 210 can be configured with special end effectors to manipulate squeegee blades, tooling and paste pans to ensure thorough cleaning.

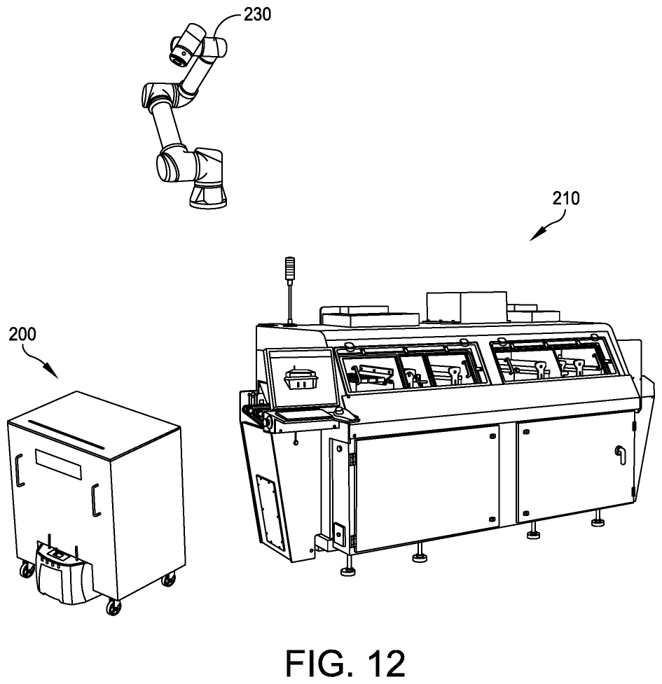

Referring to FIG. 12, as the movable cart 200 approaches the cleaning station 210, a robotic arm 230 moves stencil from movable cart to the cleaning station in either a horizontal orientation or a vertical orientation for cleaning. In one embodiment, the robotic arm is constructed similarly as the robotic arm disclosed in U.S. patent application Ser. No. 16/897,493 titled AUTOMATED PRINTER ROBOTIC ARM, filed on Jun. 10, 2020, which is incorporated herein by reference and owned by Illinois Tool Works Inc., the assignee of the present disclosure.

In some embodiments, items supported by trays are cleaned in the same way as stencils. The robotic arm 230 removes tooling and squeegee blades from the tray and places them in the cleaning station 210 independently.

In some embodiments, the cleaning station 210 can be configured to include special end effectors on the robotic arm 230 to manipulate squeegee blades, tooling and paste pans to ensure thorough cleaning.

In some embodiments, the cleaning station is an Aquastorm® series cleaning platform offered by ITW Electronic Assembly Equipment of Camdenton, Mo.

In some embodiments, the stencil and the tooling tray with squeegee blades and/or tooling are automatically loaded to spray in the cleaning system 210.

In some embodiments, the cleaning station 210 is configured to fully clean and dry product loaded into same or movable cart 200.

In some embodiments, the movable cart 200 can be configured to reclaim solder paste from the stencil as noted below.

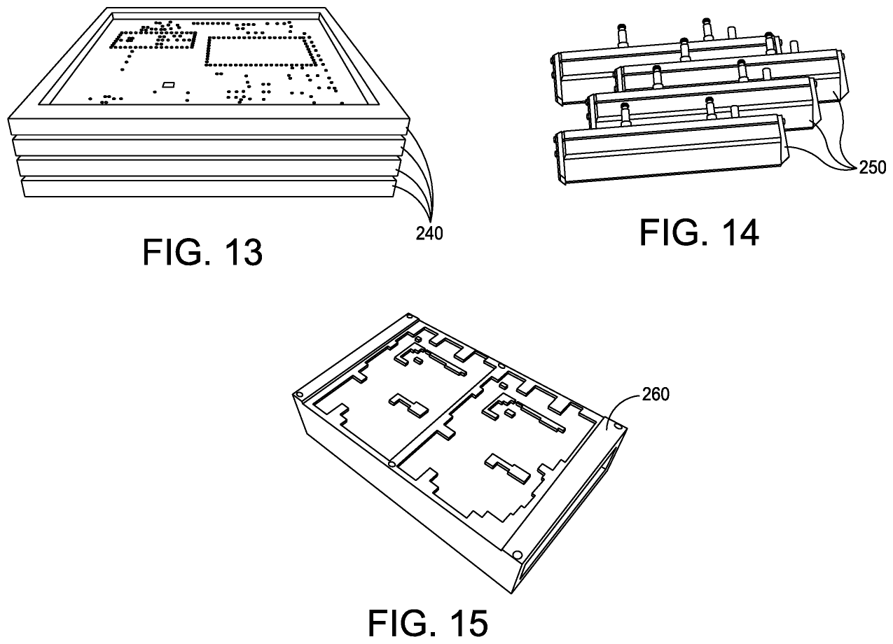

FIG. 13 illustrates exemplary items, such as stencils, each indicated at 240, that can be stored on the movable cart 200 and moved between the stencil printer 205 and the cleaning station 210.

FIG. 14 illustrates exemplary items, such as squeegee blades, each indicated at 250, that can be stored on the movable cart 200 and moved between the stencil printer 205 and the cleaning station 210.

FIG. 15 illustrates exemplary items, such as tooling 260, that can be stored on the movable cart 200 and moved between the stencil printer 205 and the cleaning station 210.

In some embodiments, the movable cart 200 can be configured as part of a solder paste reclamation or recovery system. The solder paste recovery system can include a paste pan, which is sometimes referred to as a paste receptacle or a receptacle herein. In one embodiment, the paste pan includes a flat bottom wall, a back wall and two side walls. Solder paste contained within the paste pan is removed from the stencil printer 205 and saved for future use. The paste pan having reclaimed solder paste is configured to be moved out of the stencil printer 205 onto the movable cart 200. Once on the movable cart 200, the paste pan having the reclaimed solder paste is transported to a reclamation station, which is configured to receive the paste pan and remove the solder paste from the paste pan for reclamation.

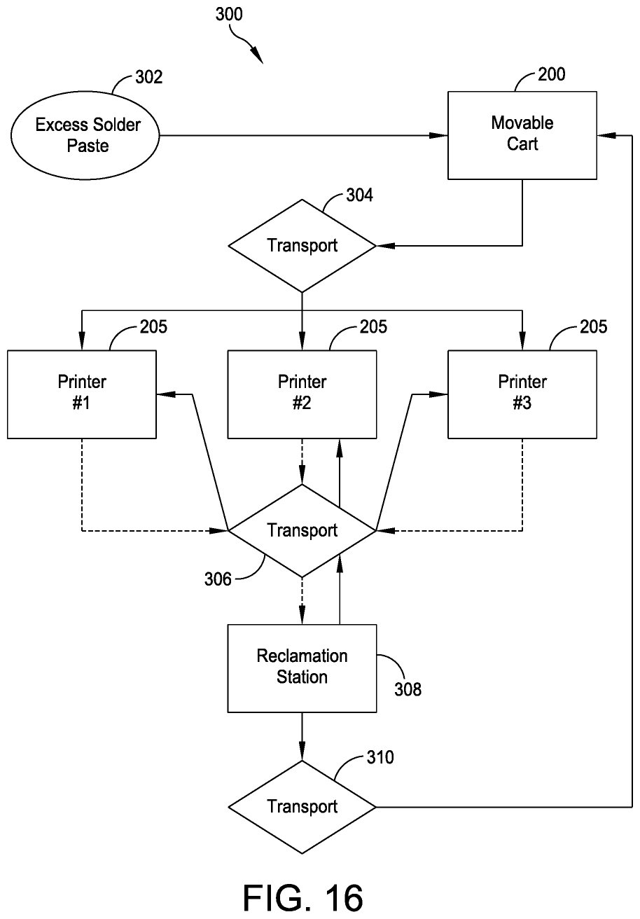

Referring to FIG. 16, in one embodiment, a method of reclaiming solder paste from a stencil printer is generally designated at 300. Excess solder paste on a stencil, which is indicated at 302, that is scheduled to be replaced is valuable. Presently, excess solder paste is manually removed from the stencil and stored for future use. A system for automating the reclamation of excess solder paste can be found in U.S. patent application Ser. No. 16/897,526 titled SOLDER PASTE BEAD RECOVERY SYSTEM AND METHOD, filed on Jun. 10, 2020, which is incorporated herein by reference and owned by Illinois Tool Works Inc., the assignee of the present disclosure. Solder paste reclaimed from a stencil printer, such as stencil printer 205, is deposited on a tray. As shown, a movable cart, such as movable cart 200, is transported at 304 to one of several stencil printers identified by “Printer 1,” “Printer 2” and “Printer 3” in FIG. 16. The stencil printers can be part of a single production line used to fabricate printed circuit boards or part of several production lines. The number of stencil printers can vary. The movable cart is docked to the designated stencil printer in the manner described above. Once docked, the reclaimed solder paste (on a tray) is removed from the stencil printer and transferred to the movable cart. The reclaimed solder paste (on the tray) is transported at 306 by the movable cart to a solder paste reclamation station 308. The solder paste can be preserved for future use. The reclaimed solder paste can be transported back onto the movable cart at 310, where the process begins anew.

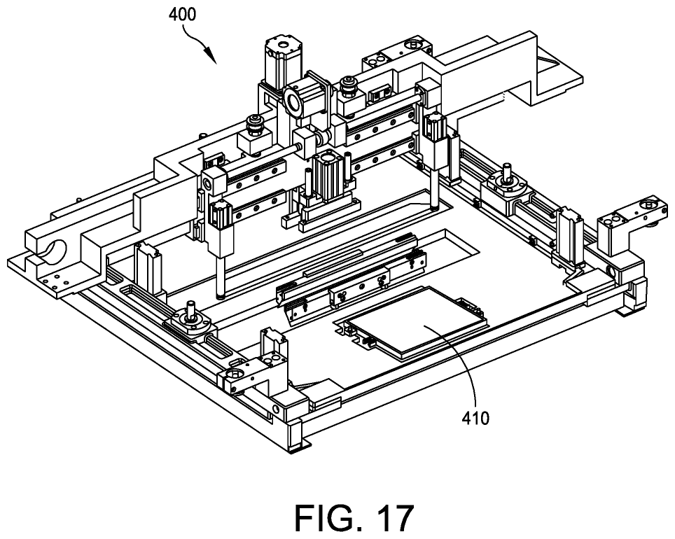

Referring to FIG. 17, a system for reclaiming excess solder paste is generally indicated at 400. As shown, the system 400 includes a paste pan 410, which essentially serves as a tray to contain excess solder paste left on the stencil.

In some embodiments, the paste pan 410 is processed through an EVT cleaner, for example, in which the paste pan is cleaned. The paste pan 410 may have a full solder paste bead or residue from previous transfers and is cleaned similarly to the cleaning of the stencil described above.

In some embodiments, the solder paste recovery system and related methods may be performed under the control of a controller. Specifically, the controller can be configured to know when to perform a solder recovery process.

In some embodiments, the stencil printer is configured to move the paste pan into and out of the stencil printer to the movable cart. In one embodiment, a print head assembly, such as print head assembly 20 of the stencil printer 10, can be configured to move and shuttle the paste pan to a solder paste recovery station.

In some embodiments, the movable cart includes a controller that is adapted to control the operation of the movable cart based on operational parameters obtained by the controller. The controller can be configured to communicate with the controller of the stencil printer and a controller of the cleaning station, and/or a controller associated with the production line. In one embodiment having multiple movable carts, the controller may embody a plurality of controllers provided in each movable cart that communicates with one another over a controller area network (CAN) Bus or other type of network. In other embodiments, a master controller may be provided to control the operation of the controllers of the movable carts. Each movable cart may be provided with a display, which is operably coupled to the controller. The display is adapted to display the operational parameters of the movable cart, such as, but not limited to, the number of clean and used stencils or items provided on trays. Suitable monitors may be provided to acquire such information. Alternatively, or in addition to the foregoing embodiment, the operational parameters may be displayed on the display provided within the stencil printer and the cleaning station, and/or a display associated with the production line.

In other embodiments, the movable cart may be controlled by the controller of the stencil printer, the cleaning station and/or a controller associated with the production line. The controller can be a controller dedicated to one or more movable carts.

In some embodiments, material identification for items on the movable cart can include a device to manipulate the item and a scanner to scan and identify the item. In one embodiment, a barcode to identify the items can be implemented. For example, the barcode can include a 1D scanner for UPC codes, a 2D scanner for QRC codes, a printed label applied on the item or a laser etched label etched on the item. In another embodiment, an RFID system to identify the items can be implemented. For example, the RFID system can include an RFID tag applied to the item and an RFID reader associated with the movable cart. With an RFID system, line-of-site between the reader and the item is not required. Moreover, scanning is not required to identify all items within the movable cart. In another embodiment, an imaging or vision system to identify the items can be implemented. The vision system could be an imaging system similar to the imaging system 30 associated with the stencil printer 10, and can be associated on the stencil printer, off the stencil printer or on the movable cart.

In some embodiments, a database is provided to keep track of items stocked on the movable cart. In one embodiment, the database may include an open application (App) architecture and be configured to push data to the stencil printer. The movable cart can be configured to communication with the stencil printer to push/pull data to stencil printer and/or the production line or configured to communicate with the production line directly. The database can include job information or material information. The database further can communicate with a manufacturing execution system (MES) associated with the production line, the stencil printer, or both. The MES system can be configured to know which materials are required for a production run. The movable cart can be configured to communicate with the MES system to adjust delivery of items to the stencil printer.

The database further can be configured to retrieve information about items based on identification, e.g., a barcode number. In one embodiment, a central management system can be provided in which the stencil printer, the cleaning station and/or the movable cart is programmed to accept material coming from movable cart. The movable cart is programmed to update the database to identify the materials on the movable cart, load information into the database associated with the movable cart and/or the stencil printer from a network, which is tied back to the MES system.

The database further can be configured to store additional information, such as usage and consumption. The database can be configured to store information locally or remotely, and can be configured to store data associated with one or more production runs. For example, the database can be configured to obtain and store data including but not limited to traceability of stencils and/or trays.

The database can be configured to share prediction data when replacement/replenishment is needed. For example, with respect to storing information related to stencils and/or trays, the database can be configured to perform one or more operation. The database can be configured to share prediction data for other changeable/consumable items, such as for the stencils and/or trays.

The database can be configured to store data associated with lot traceability. In addition, RFID or mechanical keying of a board or a stencil frame of the stencil is provided to ensure correct alignment/orientation/direction/front-back/top-bottom when these items are inserted into the stencil printer. This information can be used to verify correct orientation and/or fit before the items are transported from the warehouse and/or before the items are installed in the stencil printer. A low-cost reader can perform this function.

Referring back to FIG. 7, in one embodiment, the remote control 124 can be configured to communicate with a database 130 via the cloud 132 or ISP to provide the functions described above. In another embodiment, the database 130 can be part of a computer control system for the stencil printer, the cleaning station or the movable cart or a production line.

In some embodiments, the movable cart can be configured to store materials. The movable cart can be configured to be flexible to accommodate where the materials come from and where the materials go to. In addition, the movable cart can be configured to identify where a particular material is located on the movable cart. In certain embodiments, the location, whether by auto delivery or manual delivery, is remote, local, on the movable cart, and/or on the stencil printer.

In some embodiments, the movable cart can be configured to perform inventory control. Specifically, the movable cart can be configured to identify where material is located, how much material is used, how the material is used, when the material is used, tie the material and information about the material to a customer inventory control system, and track material type consumed per board or lots of boards.

In some embodiments, the movable cart can be configured to organize items stored on the movable cart. As mentioned above, in one embodiment, one movable cart can be provided to store, transport and deliver multiple resources, including but not limited to stencils and/or trays. In another embodiment, the movable cart can be configured to store, transport and deliver a single resource or item to the stencil printer and/or the cleaning station. For example, the movable cart can be configured to store multiple stencils and/or trays. The movable cart can be configured to service multiple production lines. In another embodiment, the movable cart can be configured to service one stencil printer.

In some embodiments, the movable cart can be configured to transport items from the movable cart to the stencil printer and from the stencil printer to the movable cart, and be able to account for elevation differences between the movable cart and the stencil printer. The transportation can be automated or manual. In one embodiment, movable cart can be moved by automatically guided vehicle (AVG) technology associated with the movable cart or remotely controlled. In another embodiment, the movable cart can be configured to move autonomously. In another embodiment, the movable cart can be configured to be moved manually. In yet another embodiment, the movable cart can be configured to move items stored on the movable cart automatically and/or manually. For example, the movable cart can be configured to move items automatically, and can provide for an interruption of a pre-planned activity in which the items are moved manually.

In some embodiments, timing associated with performing transportation functions of the movable cart can be programmed to account for shift change, e.g., a personnel shift, scheduled maintenance, on demand activities, e.g., a recipe change, and predictive events (just-in-time replacements). The timing can be programmed to meet multiple line balance control requirements, with one or more movable carts and to meet real-time on-demand material supply demands on the production line.

In some embodiments, the movable cart is configured to perform inspection. For example, the movable cart can inspect on cart and off cart items including stencils and/or trays. In one embodiment, a vision system associated with the movable cart can be configured to obtain images of the items. The vision system in conjunction with the controller, can be configured to inspect for cleanliness, damage, wear, and identification readability, e.g., is the barcode label worn, dirty or torn. The vision system can embody any type of 2D, 3D or color camera.

In some embodiments, the movable cart is configured to interface with the stencil printer, both from a mechanical interface and an electronics communication interface. In one embodiment, the movable cart can be configured with a unique mechanical interface that mates with a unique mechanical interface of the stencil printer and a unique mechanical interface of the cleaning station. The unique mechanical interfaces can be geometric features. In another embodiment, the movable cart can be configured with pins that are received within guides associated with the stencil printer to register the movable cart with the stencil printer prior to fully docking the movable cart. Similarly, the cleaning station can include guides to register the movable cart with the cleaning station. The pins and guides can be reversed, with the pins provided on the stencil printer and/or the cleaning station and the guides provided in the movable cart. Other types of guides can be used, such as electrical/magnetic guides, vision guides, sensors, latches, etc.

In some embodiments, the interface and the docking station can be configured with a clamping system to maintain the movable cart in place with respect to the stencil printer and the cleaning station. For example, a magnetic clamping system can be employed.

In some embodiments, the stencil printer and/or the cleaning station can be configured with multiple docking stations, e.g., five docking stations. The docking station can be provided at a front of the stencil printer and/or the cleaning station or at a back of the stencil printer and/or the cleaning station.

The movable cart and/or the stencil printer and/or the cleaning station can be configured to verify whether the movable cart can be docked and interface with the stencil printer and/or the cleaning station. In one embodiment, verification can be provided to confirm that the movable cart is in position and ready to interface with the stencil printer and/or the cleaning station. This verification process can further determine whether correct materials are on the movable cart and whether the movable cart material information can be received from MES system, or locally identified. If not correct, the movable cart can be configured to activate an alarm and/or alert an operator if wrong or damaged materials are on the movable cart.

In some embodiments, the movable cart can be configured with actuation devices or actuators to move items onto and off of the movable cart once the movable cart is docked to the stencil printer and/or the cleaning station. Embodiments of the actuators can be implemented on the movable cart, the stencil printer and/or the cleaning station. In another embodiment, the items can be manually loaded and unloaded from the movable cart.

In some embodiments, the movable cart can be configured to interface with a production line. With this embodiment, the operator of the production line can confirm the correct location and acknowledge receipt of the movable cart on the stencil printer and/or the cleaning station.

In some embodiments, the movable cart can be configured to communicate with the stencil printer, the cleaning station, the production line, and/or select machines within the production line via an open platform. Communication systems can include a wired system, a wireless system (through a common network, mesh, Bluetooth, Wi-Fi, Zigbee, WAN, Nodes, Li-Fi, etc.), a combination of wired and wireless systems, and infrared (IR) system.

In some embodiments, the movable cart can be configured with a dedicated power source. In one embodiment, the movable cart includes a battery configured to power automated components provided in the movable cart, e.g., mechanisms used to move stencils and/or trays into and out of the movable cart. In other embodiments, the movable cart can be configured with an uninterruptible power supply. The power source can be configured to support actuation while “docked” (high-voltage from stencil printer when docked, otherwise low-voltage when undocked). The power source can be configured to recharge for autonomous operations, e.g., recharge a battery from power provided by the stencil printer.

In some embodiments, the movable cart can be configured to function with the stencil printer. For example, the movable cart can be configured to provide a handshaking function with the stencil printer 10 prior to a transfer of an item, e.g., “please give me stencil #1234.” The movable cart and the stencil printer can be configured with a communication protocol and/or a library reference on what is available to consume. The movable cart can be configured to determine whether the movable cart has correct items. The handshaking function can be configured to ensure the correct transfer of an item, e.g., “here's stencil #1234,” and/or the subsequent transfer of an item, e.g., “I now have stencil #1234.” In one embodiment, a mobile device can be configured to scan and identify items in the movable cart, and determine, for example, whether the items are ready for use, require cleaning, etc.

In some embodiments, the movable cart can be configured to address errors associated with handling and recovering items in the movable cart. For example, the movable cart can be configured to detect an incomplete action by one party, an incomplete transfer of an item, e.g., a stuck or jammed item, a dropped transfer, e.g., “I passed stencil #1234 to you, don't you have it?,” and a manual intervention or override, e.g., “here, let me help you.” In one embodiment, a controller associated with the movable cart can be configured to perform static discharge control, data recovery and/or security.

In some embodiments, the movable cart can be configured with a higher level of capability. In addition to indexing all the equipment to the correct height, the movable cart would need to pull in/push out all equipment for machine gantries to attach.

In some embodiments, existing machine gantries, rails and print head of the stencil printer can be configured to shuttle items in and out.

In some embodiments, the movable cart can be configured to communication with the stencil printer, the production line and a warehouse associated with the production line.

In some embodiments, the movable cart can be configured with an electrical/pneumatic interface.

In some embodiments, the movable cart can be configured to track consumables—new and used on the movable cart, e.g., stencils and/or trays, including location, temperature and other data.

In some embodiments, the movable cart can be configured to store and supply stencils and/or items on trays for duration of a production run.

In some embodiments, the movable cart can be configured to scan all consumables with a suitable scanning device, such as a barcode reader or RFID reader.

In some embodiments, the movable cart can be configured with an indexing mechanism to properly locate consumables.

In some embodiments, the movable cart can be configured with a bypass switch to disconnect the movable cart from the stencil printer 10 if the movable cart has an issue.

In some embodiments, the movable cart can be configured to be moved manually or by an automated guided vehicle (AGV).

In some embodiments, the movable cart can be configured to dock and interface with the stencil printer.

In some embodiments, the movable cart can be configured to service multiple stencil printers.

In some embodiments, the movable cart can be configured to be dedicated to one consumable item, e.g., stencils, or multiple consumable/changeover items.

In some embodiments, the movable cart can be configured to transport and present the consumables to be cleaned at a remote station.

In some embodiments, the movable cart can be configured to be refilled at a stockroom associated with a warehouse.

In some embodiments, the movable cart can be configured to be climate controlled, either actively or passively.

In some embodiments, the movable cart can be configured be controlled by an application (App) capable for smartphone integration.

As used herein, an “automated” or “fully automated” changeover describes the replacement or replenishment of an item without human intervention.

As used herein, a “partially automated” changeover describes the replacement or replenishment of an item with some or limited human intervention.

As used herein, “transport” or “transporting” describes moving an item from one position to another, either manually or with a machine.

As used herein, “install” or “installing” describes the process of placing an item in a position ready for use.

As mentioned above, the movable cart can be employed to replace other items within the stencil printer. For example, the stencil wiper assembly includes consumables, e.g., paper and solvent, which can be automatically replaced by the movable cart.

The concepts disclosed herein may be employed in other types of equipment used to fabricate electronic substrates, including dispensers, pick-and-place machines, reflow ovens, wave soldering machines, selective solder machines, inspection stations, and cleaning stations. For example, the concepts directed to replacing paste cartridges can be employed in dispensers used to dispense viscous material. In another example, the concepts directed to replacing tooling can be employed in dispensers and in pick-and-place machines used to mount electronic components onto electronic substrates. In another example, the concepts directed to replacing items can be employed in replacing solder within wave soldering and selective soldering machines and cleaning product within cleaning stations.

Having thus described several aspects of at least one embodiment, it is to be appreciated various alterations, modifications, and improvements will readily occur to those skilled in the art. Such alterations, modifications, and improvements are intended to be part of this disclosure, and are intended to be within the scope of the disclosure. Accordingly, the foregoing description and drawings are by way of example only.

What is claimed is:

1. A method of removing and cleaning a stencil in a stencil printer, the method comprising:
removing a used stencil from a stencil printer with the assistance of a movable cart;
transporting the used stencil by the movable cart to a cleaning station;
removing the used stencil from the movable cart;
delivering the used stencil to the cleaning station;
cleaning the stencil;
removing a cleaned stencil from the cleaning station; and
delivering the cleaned stencil to the movable cart for future use.

2. The method of claim 1, wherein the method is performed without the need of human intervention.

3. The method of claim 1, wherein the method is performed on at least two stencil printers.

4. The method of claim 1, wherein the movable cart is configured to transport other items, including trays configured to support squeegee blades and tooling.

5. The method of claim 4, wherein the movable cart includes an interface configured interact with a docking station associated with the stencil printer and the cleaning station.

6. The method of claim 4, wherein the movable cart includes at least one pin that is received within at least one guide associated with the stencil printer and the cleaning station to register the movable cart with the stencil printer prior and the cleaning station, respectively, to fully dock the at least one delivery device.

7. The method of claim 1, further comprising identifying an item by obtaining an image of the item and verifying whether the item is the correct item based on a predetermined identification mark.

8. A system of removing and cleaning a stencil in a stencil printer, the system comprising:
a stencil printer having a removable stencil;
a cleaning station; and
a movable cart configured to
remove a used stencil from a stencil printer,
transport the used stencil cart to the cleaning station,
remove the used stencil from the movable cart,
deliver the used stencil to the cleaning station,
remove a cleaned stencil from the cleaning station, and
deliver the cleaned stencil to the movable cart for future use.

9. The system of claim 8, wherein the system further includes a paste pan configured to support excess solder paste.

10. The system of claim 8, further including at least one additional stencil printer.

11. The system of claim 8, wherein the movable cart is configured to transport other items, including trays configured to support squeegee blades and tooling.

12. The system of claim 8, wherein the movable cart includes an interface configured to interact with a docking station associated with the stencil printer and a docking station associated with the cleaning station.

13. The system of claim 8, wherein the movable cart includes at least one pin that is received within at least one guide associated with the stencil printer and at least one guide associated with the cleaning station to register the movable cart with the stencil printer and the cleaning station, respectively, prior to fully docking the movable cart.

14. The system of claim 8, wherein the movable cart includes an imager to identify an item by obtaining an image of the item and verifying whether the item is the correct item based on a predetermined identification mark.

15. A method of reclaiming solder paste from a stencil printer, the method comprising:
removing excess solder paste from a stencil printer with the assistance of a movable cart;
transporting the excess solder paste by the movable cart to a solder paste reclamation station;
removing the excess solder paste from the movable cart;
delivering the excess solder paste to the solder paste reclamation station; and
storing the excess solder paste for future use.

16. The method of claim 15, wherein the excess solder paste is contained within a paste pan.

17. The method of claim 15, wherein the movable cart includes an interface configured interact with a docking station associated with the stencil printer and the solder paste reclamation station.

18. The method of claim 15, wherein the movable cart includes at least one pin that is received within at least one guide associated with the stencil printer and the solder paste reclamation station to register the movable cart with the stencil printer prior and the solder paste reclamation station, respectively, to fully dock the at least one delivery device.

19. The method of claim 15, further comprising identifying an item by obtaining an image of the item and verifying whether the item is the correct item based on a predetermined identification mark.

20. A system of reclaiming solder paste from a stencil printer, the system comprising:
a stencil printer;
a solder paste reclamation station; and
a movable cart configured to
remove excess solder paste from the stencil printer;
transport the excess solder paste to the solder paste reclamation station;
remove the excess solder paste from the movable cart; and
deliver the excess solder paste to the solder paste reclamation station.

21. The system of claim 20, wherein the excess solder paste is contained within a paste pan.

22. The system of claim 20, further including at least one additional stencil printer.

23. The system of claim 20, wherein the movable cart is configured to transport other items, including stencils and trays configured to support squeegee blades and tooling.

24. The system of claim 20, wherein the movable cart includes an interface configured to interact with a docking station associated with the stencil printer and a docking station associated with the solder paste reclamation station.

25. The system of claim 20, wherein the movable cart includes at least one pin that is received within at least one guide associated with the stencil printer and at least one guide associated with the solder paste reclamation station to register the movable cart with the stencil printer and the solder paste reclamation station, respectively, prior to fully docking the movable cart.

26. The system of claim 20, wherein the movable cart includes an imager to identify an item by obtaining an image of the item and verifying whether the item is the correct item based on a predetermined identification mark.
